(19) United States
(12) Patent Application Publication
(10) Pub. No.: US 2021/0056181 A1
(43) Pub. Date: Feb. 25, 2021

(54) INFORMATION PROCESSING METHOD, INFORMATION PROCESSING APPARATUS, AND MEDIUM

(71) Applicant: Mercari, Inc., Tokyo (JP)

(72) Inventor: Keisuke SOGAWA, Tokyo (JP)

(21) Appl. No.: 16/983,168

(22) Filed: Aug. 3, 2020

(30) Foreign Application Priority Data
Aug. 20, 2019 (JP) 2019-150451

(51) Int. Cl. G06F 21/12; G06F 21/32; G06Q 20/10; G06Q 20/20

(52) U.S. Cl. CPC G06F 21/121; G06F 21/32; G06F 2221/2149; G06Q 20/204; G06Q 20/108

(57) ABSTRACT

An information processing method executed by an information processing apparatus, includes recording a first user in association with a first information processing terminal used by the first user; and restricting use of a service using the first information processing terminal by the first user and a second user, in response to detecting an illegal operation performed by the first user.

The present application is based on and claims the benefit of priority of Japanese Priority Application No. 2019-150451, filed on Aug. 20, 2019, the entire contents of which are hereby incorporated by reference.

### FIELD

The present disclosure relates to an information processing method, an information processing apparatus, and a medium.

### BACKGROUND

Conventionally, in services provided via a network such as the Internet, techniques have been known that stop (restrict, prohibit) the use of an account of a user who has committed an illegal operation (see, for example, Patent Document 1).

### RELATED ART DOCUMENTS

### Patent Documents

Patent Document 1: Japanese Laid-Open Patent Application No. 2016-118931

However, in such conventional techniques, there has been a problem that a user whose account was stopped due to an illegal operation may continue to use services, for example, by using another account.

### SUMMARY

According to an embodiment in the present disclosure, an information processing method executed by an information processing apparatus, includes recording a first user in association with a first information processing terminal used by the first user; and restricting use of a service using the first information processing terminal by the first user and a second user, in response to detecting an illegal operation performed by the first user.

### BRIEF DESCRIPTION OF DRAWINGS

FIG. 1 is a diagram illustrating a configuration of a communication system according to an embodiment in the present disclosure;

FIG. 2 is a diagram illustrating an example of a hardware configuration of an information processing apparatus according to an embodiment;

FIG. 3 is a diagram illustrating an example of a block diagram illustrating a configuration of a server and a terminal according to an embodiment;

FIG. 4 is a diagram illustrating an example of a sequence of steps for restricting the use of services on an illegally used terminal according to an embodiment;

FIG. 5A is a diagram illustrating an example of terminal management data stored in a terminal management DB on a terminal management server according to an embodiment;

FIG. 5B is a diagram illustrating an example of user information stored in a user information storage unit according to an embodiment;

FIG. 6 is a sequence chart illustrating an example of steps for canceling restrictions of the use of services on an illegally accessed terminal according to an embodiment; and

FIG. 7 is a diagram illustrating an example of a display on a terminal according to an embodiment.

### DESCRIPTION OF EMBODIMENTS

### <Legal Compliance>

The disclosures described herein, when implemented, are made in compliance with the laws and regulations of countries in which the disclosure is implemented. Also, the disclosures described herein are implemented with all possible changes, substitutions, variations, transformations, and modifications that may be made by a person skilled in the art necessary to comply with the laws and regulations of the countries.

Embodiments for carrying out processing of restricting the use of services by a user who has committed an illegal operation on the terminal will be described in the following disclosure with reference to the drawings. According to an embodiment in the disclosure, it is possible to provide a technique that properly restricts the use of services by a user who has committed an illegal operation.

### <System Configuration>

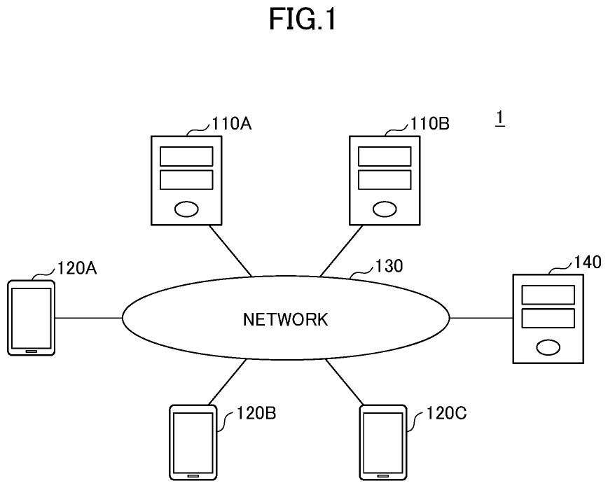

FIG. 1 is a diagram illustrating a configuration of a communication system 1 according to an embodiment in the present disclosure. As depicted in FIG. 1, in the communication system 1, servers 110A and 110B; terminals 120A, 120B, and 120C; and a terminal management server 140 are connected via a network 130.

In the present disclosure, in the case where it is not necessary to make a distinction between the server 110A and the server 110B, the server 110A and/or the server 110B may be referred to as the server(s) 110. Note that the server 110 is an example of an “information processing apparatus”. The terminal management server 140 is an example of an “external information processing apparatus”.

In the present disclosure, in the case where it is not necessary to make a distinction among the terminals 120A, 120B, and 120C, the terminals 120A, 120B, and/or 120C may be referred to as the terminal(s) 120 (an example of an “information processing terminal”).

In the present disclosure, in the case where it is not necessary to make a distinction among the server 110, the terminal 120, and the terminal management server 140, each of the server 110, the terminal 120, and the terminal management server 140 may be referred to as an information processing apparatus 200. Note that the number of information processing apparatuses 200 connected to the network 130 is not limited to the number as depicted in FIG. 1.

The server 110 provides predetermined services to the terminals 120 used by users via the network 130. The predetermined services include, but are not limited to, for example, settlement services, financial services, electronic commerce services, social networking services (SNS) represented by messaging services using instant messengers and the like, providing services of contents such as music, videos, books, and the like. Note that electronic commerce services may include, for example, an Internet mail order service, an interpersonal trading services such as a flea market service and an Internet auction service, an instant purchase (pawnshop) service, and the like. When users use the predetermined services via terminals 120, the server 110 can provide the predetermined services to the one or more terminals 120.

The terminal 120 is, for example, a smartphone, a tablet, a personal computer, or the like used by a user, and performs processing for using various services provided on the server 110.

The terminal management server 140 is, for example, a server operated by a manufacturer (maker, vendor) of the terminals 120 or a manufacturer of the OS on the terminal 120. The terminal management server 140 records information set by the server 110 for each terminal 120 (terminal state) on the terminal management DB 141 (not illustrated). Also, in response to a request from the server 110, the terminal management server 140 replies to the request with the information set by the server 110 for each terminal 120.

When necessary, a terminal used by a user X will be referred to as the terminal 120X, and user information in a predetermined service associated with the user X or the terminal 120X will be referred to as the user information X. Note that user information is information on a user associated with an account used by the user for a predetermined service. The user information includes, but is not limited to, for example, information associated with the user such as a name of the user, an icon image of the user, the age of the user, the gender of the user, an address of the user, a hobby or taste of the user, and an identifier of the user; balance information on an electronic value (e.g., electronic money) associated with the user; and credit card information (e.g., a credit card number) associated with the user. The user information may be entered by the user or provided by a predetermined service, and may be any one of the above items or a combination of the above items.

The network 130 plays a role in connecting two or more information processing apparatuses 200. The network 130 means a communication network that provides a connection path through which data can be transmitted and received after the terminal 120 has established a connection to the server 110.

One or more portions of the network 130 may be a wired network or a wireless network. The network 130 includes, but is not limited to, for example, an ad hoc network, intranet, extranet, Virtual Private Network (VPN), local area network (LAN), wireless LAN (WLAN), wide area network (WAN), wireless WAN (WWAN), metropolitan network (MAN), part of the Internet, part of a public switched telephone network (PSTN), cellular network, ISDN (Integrated Service Digital Network), Wireless LAN, LTE (Long Term Evolution), CDMA (Code Division Multiple Access), Bluetooth (registered trademark), satellite communication, or any combination of two or more of these. The network 130 may include one or more networks.

The information processing apparatus 200 may be any information processing apparatus as long as being capable of implementing processes, functions, and methods described in the present disclosure.

The information processing apparatuses 200 include, but are not limited to, for example, a smartphone, cellular phone (feature phone), computer (including, but not limited to, e.g., a desktop, laptop, tablet, etc.), server device, media computer platform (including, but not limited to, e.g., a cable, satellite set-top box, digital video recorder, etc.), handheld computer device (including, but not limited to, e.g., a PDA (Personal Digital Assistant), e-mail client, etc.), wearable terminal (including, but not limited to, e.g., a glass-type device, watch-type device, etc.), other types of computers and communication platforms.

### <Hardware Configuration>

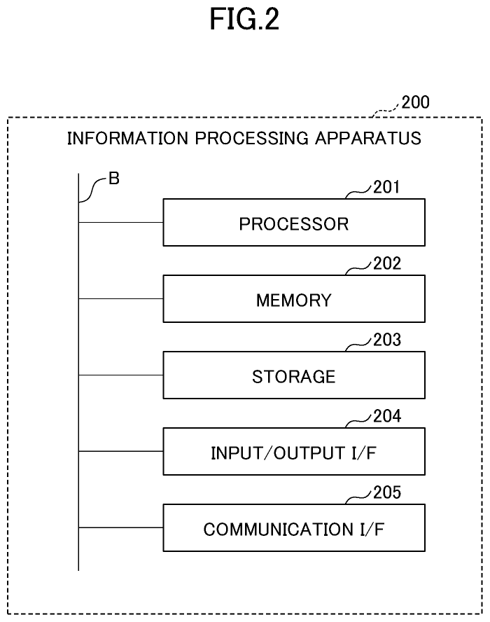

The hardware configuration of the information processing apparatus 200 included in the communication system 1 will be described with reference to FIG. 2. FIG. 2 is a diagram illustrating an example of a hardware configuration of the information processing apparatus 200 according to the present embodiment.

The information processing apparatus 200 includes a processor 201, a memory 202, a storage 203, an input/output interface (input/output I/F) 204, and a communication interface (communication I/F) 205. These elements of the information processing apparatus 200 are interconnected via a bus B as a non-limiting example.

The information processing apparatus 200 implements processes, functions, and/or methods described in the present disclosure through interoperation among the processor 201, the memory 202, the storage 203, the input/output I/F 204, and the communication I/F 205.

The processor 201 performs processes, functions, and methods implemented by codes or instructions included in a program stored in the storage 203. The processor 201 includes, but are not limited to, for example, a central processing unit (CPU), a micro processing unit (MPU), a GPU (Graphics Processing Unit), a microprocessor, a processor core, multiprocessors, an ASIC (Application-Specific Integrated Circuit), an FPGA (Field Programmable Gate Array), and the like. Alternatively, processes disclosed in the embodiments may be implemented by logic circuits (hardware) formed as an integrated circuit (IC) chip, an LSI (Large Scale Integration) chip, or a dedicated circuit. Also, these circuits may be implemented by one or more integrated circuits, and multiple processes illustrated in the embodiments may be implemented by a single integrated circuit. Also, LSI may be referred to as VLSI, super LSI, or ultra LSI, in accordance with different levels of integration.

The memory 202 temporarily stores a program loaded from the storage 203, to provide a working area for the processor 201. Various items of data generated while the processor 201 executes the program are temporarily stored in the memory 202. The memory 202 includes, but is not limited to, for example, a RAM (Random Access Memory), a ROM (Read-Only Memory), and the like.

The storage 203 stores one or more programs. The storage 203 includes, but is not limited to, for example, an HDD (hard disk drive), an SSD (solid-state drive), a flash memory, and the like.

The communication I/F 205 transmits and receives various items of data via the network 130. The communication may be performed by wire or wirelessly, and any communication protocol may be used as long as being capable of performing bidirectional communication. The communication I/F 205 performs communication with another information processing apparatus via the network 130. The communication I/F 205 transmits various items of data to the other information processing apparatus according to instructions from the processor 201. Also, the communication I/F 205 receives various items of data transmitted from the other information processing apparatus and transfers the received data to the processor 201.

The input/output I/F 204 includes an input device for inputting various operations to the information processing apparatus 200 and an output device for outputting results processed by the information processing apparatus 200. The input/output I/F 204 may have the input device and the output device integrated, or may have the input device and the output device separated.

The input device may be implemented by any device among all types of devices that can receive input from a user and transfer information on the input to the processor 201, or by a combination of these devices. The input devices include, but are not limited to, for example, touch panels, touch displays, hardware keys such as a keyboard; pointing devices such as a mouse; cameras (operational input via images); and microphones (operational input via voice).

The output device may be implemented by any device among all types of devices that can output results processed by the processor 201, or by a combination of these devices. In the case of outputting a processed result as a video or a moving image, the output device may be implemented by any device among all types of devices that can display data to be displayed according to the data written into a frame buffer, or by a combination of these devices. The output devices include, but are not limited to, for example, touch panels, touch displays, monitors (including, but not limited to, e.g., liquid crystal displays, OELDs (Organic Electroluminescence Displays)), head-mounted displays (HDMs), projection mapping, holograms, devices capable of displaying images, text information, and the like in the air (which may be vacuum), speakers, printers, and the like. Note that these output devices may be capable of displaying display data in 3D.

The programs according to the embodiments in the present disclosure may be provided in a state of being stored in a computer-readable recording medium. The recording medium is capable of storing programs in a “non-transitory tangible medium”. The programs include, but are not limited to, for example, software programs and computer programs.

The recording media may include, where appropriate, one or more semiconductor-based or other integrated circuits (ICs) (including, but not limited to, e.g., field programmable gate arrays (FPGAs), application-specific ICs (ASICs), etc.), hard disk drives (HDDs), hybrid hard drives (HHDs), optical disks, optical disk drives (ODDs), magneto-optical disks, magneto-optical drives, floppy diskettes, floppy disk drives (FDDs), magnetic tapes, solid-state drives (SSDs), RAM drives, secure digital cards or drives, any other suitable recording media, and suitable combinations of two or more of these. The recording media may be volatile, non-volatile, or a combination of volatile and non-volatile media when appropriate.

Also, a program in the present disclosure may be provided to the information processing apparatus 200 via any transmission medium (such as a communication network or broadcasting wave) capable of transmitting the program.

Also, the embodiments in the present disclosure may also be implemented in a form of data signals embedded in a carrier wave in which a program is embodied by electronic transmission.

Note that programs in the present disclosure are implemented by using, for example, but not limited to, a scripting language such as JavaScript (registered trademark) or Python, C language, Go language, Swift, Kotlin, Java (registered trademark), or the like.

At least part of processing in the information processing apparatus 200 may be implemented by cloud computing constituted with one or more computers.

At least part of processing in the information processing apparatus 200 may be configured to be executed on another information processing apparatus. In this case, at least part of processing executed by units implemented by the processor 201 may be configured to be executed on the other information processing apparatus.

### <Other>

Unless explicitly stated otherwise, in the present disclosure, a determination may not be a requisite, and a predetermined process may be executed when a determination condition is satisfied or a predetermined process may be executed when a determination condition is not satisfied.

In the present disclosure, unless explicitly stated otherwise, or unless indicated otherwise in context, “at least one of A and B” means “A, B, or both”. Furthermore, unless explicitly stated otherwise, or unless indicated otherwise in context, “a”, “an”, or “the” means “one or more”. Therefore, in the present specification, unless explicitly stated otherwise, or unless indicated otherwise in context, “an A” or “the A” means “one or more A”.

The present disclosure encompasses all changes, substitutions, transformations, modifications, and revisions that may be made by those skilled in the art with respect to the embodiments and application examples in the present disclosure. Also, the attached claims encompass all changes, substitutions, transformations, modifications, and revisions that may be made by those skilled in the art with respect to the embodiments and application examples in the present disclosure. Further, the present disclosure encompasses any combination of one or more features of an embodiment or application example in the present disclosure and one or more features of another embodiment or application example in the present disclosure, which may be made by those skilled in the art.

In addition, references in the attached claims to a device, system, or an element of the device or the system that is adapted, arranged, capable, configurable, usable, operational, or operable to implement a particular process, function, or method encompass the device, system, or element, regardless of the device, system, element, or particular function being activated, turned on, or unlocked, as long as the device, system, or element is adapted, arranged, capable, configurable, usable, operational, or operable in that way.

Upon implementing any embodiment or application example in the present disclosure, unless explicitly stated otherwise, consent may be obtained from the user in advance or immediately before the implementation. Also, the consent may be obtained comprehensively or on each occasion of implementation.

### EMBODIMENTS

An embodiment in the present disclosure records a user in association with a terminal 120 used by the user, and when detecting an illegal operation (illegal use of a service, dishonest use of a service, fraudulent use of a service, or the like) performed by a user, restricts the use of services using the terminal 120.

According to such an embodiment, for example, it is possible to restrict the use of services by a user who has committed illegal operations appropriately. For example, in the case where a user who has committed an illegal operation or the like attempts to use a service using an account different from that used when committed the illegal operation, it is possible to restrict the use of services. Also, as illegal operations using services are reduced, for example, it is possible to obtain effects of reducing the load of the terminal 120A and the server 110, and the load of the network 130 between the terminal 120A and the server 110.

### Configuration of Embodiment

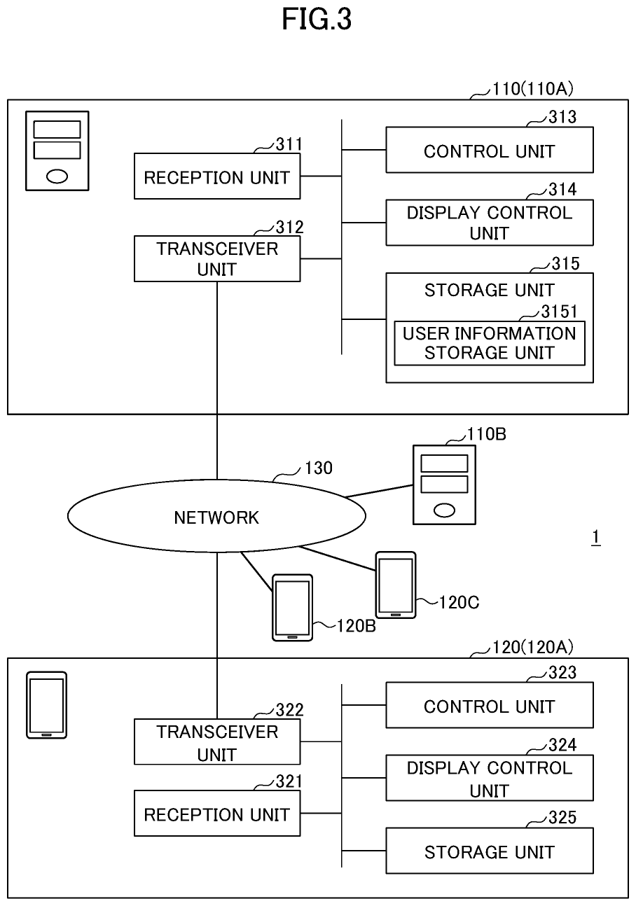

The configuration of the server 110 and the terminal 120 will be described with reference to FIG. 3. FIG. 3 is a diagram illustrating an example of a block diagram illustrating a configuration of the server 110 and the terminal 120 according to the present embodiment. Units disclosed in FIG. 3 may be implemented by interoperation among the processor 201, the memory 202, the storage 203, the input/output I/F 204, and the communication I/F 205 provided in the information processing apparatus 200.

### (1) Configuration of the Server

The server 110 includes a reception unit 311, a transceiver unit 312, a control unit 313, a display control unit 314, and a storage unit 315. Note that processes, functions, or methods of the units may be implemented by machine learning or AI (Artificial Intelligence) within a feasible range.

The reception unit 311 receives various setting operations from a provider who operates various services provided on the server 110.

The transceiver unit 312 transmits and receives data to and from the terminal 120 according to a command from the control unit 313. Note that the transceiver unit 312 establishes a session for communication with the terminal 120 using HTTPS or the like when the user of the terminal 120 is authenticated by, for example, a user ID and a password included in a login request from the terminal 120 or the like. Then, the communication address of the terminal 120 and the user ID, the store ID, or the like are stored in association with the ID of the established session for communication. Then, data is transmitted to the terminal 120 or the like, by using a connected session for communication.

The control unit 313 performs processing to provide various services such as electronic commerce services, settlement services, and the like to the user of the terminal 120. The control unit 313 associates, for example, a user with a terminal 120 used by the user, and records the associated data in the user information storage unit 3151. Also, for example, in the case of detecting an illegal operation performed by a user, the control unit 313 restricts the use of services using the terminal 120 stored in association with the user.

The display control unit 314 causes the transceiver unit 312 to transmit information for controlling a display screen on a terminal 120 or the like, according to a command from the control unit 313.

The storage unit 315 includes a user information storage unit 3151 and the like to store user information.

### (2) Configuration of the Terminal

The terminal 120 includes a reception unit 321, a transceiver unit 322, a control unit 323, a display control unit 324, and a storage unit 325. Note that processes, functions, or methods of the units may be implemented by machine learning or AI within a feasible range.

The reception unit 321 receives various operations and the like from the user of the terminal 120.

The transceiver unit 322 transmits and receives data to and from the server 110 or the like according to a command from the control unit 323. Note that the transceiver unit 322 establishes a session for communication with the server 110 using HTTPS or the like when logging in on the server 110. Then, the communication address of the server 110 or the like is stored in association with the ID of the established session for communication. Then, the transceiver unit 322 transmits data to the server 110 by using the established session for communication.

The control unit 323 performs processing to use various services provided on the server 110. The display control unit 324 controls the display screen of the terminal 120, based on information received from the server 110 according to a command from the control unit 323. The storage unit 325 stores information for using services and the like provided on the server 110.

### Processing in Embodiments

### <<Processing of Restricting the Use of Services by an Illegal User on the Terminal 120>>

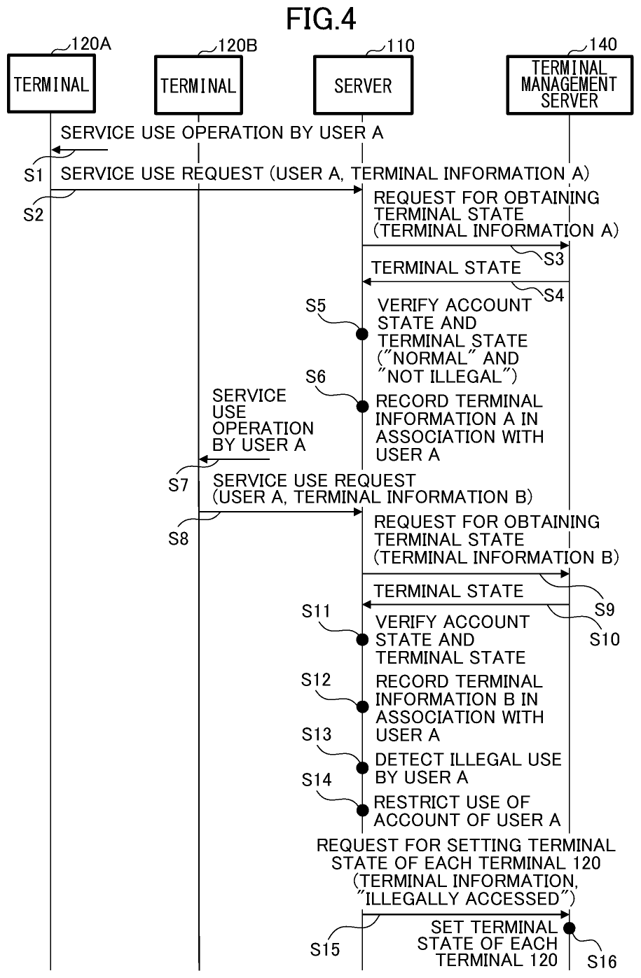

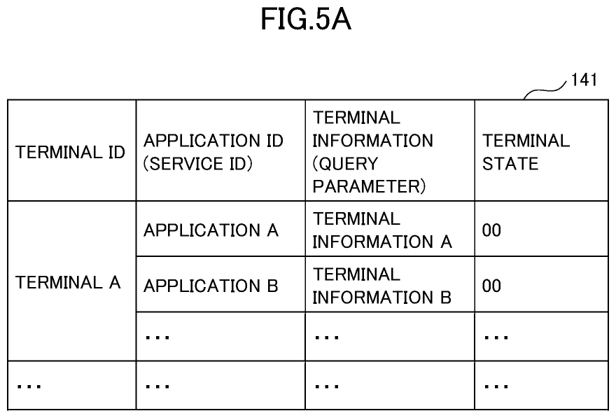

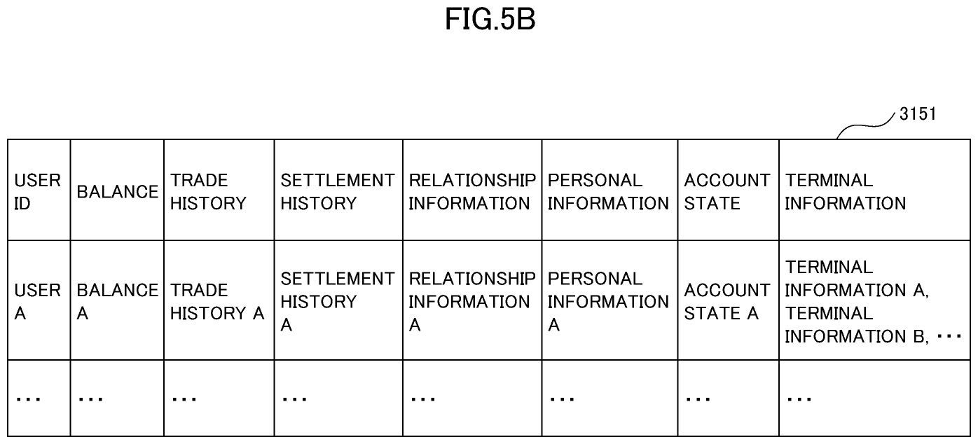

With reference to FIGS. 4 to 5B, processing for restricting the use of services performed by the user who has committed an illegal operation (illegal user) on the terminal 120 (illegally used terminal) will be described according to an embodiment. FIG. 4 is a diagram illustrating an example of a sequence of steps for restricting the use of services on an illegally used terminal according to an embodiment. FIG. 5A is a diagram illustrating an example of terminal management data stored in the terminal management DB 141 on the terminal management server 140 according to an embodiment. FIG. 5B is a diagram illustrating an example of user information stored in the user information storage unit 3151 according to the present embodiment.

At Step S1, the terminal 120A receives an operation for using a service provided on the server 110 from the user A (an example of a “first user”).

Next, at Step 2, the terminal 120A transmits information on the user A and a request for using the service including terminal information on the terminal 120A (hereafter, also referred to as “terminal information A”, an example of “pair identification information”) to the server 110. Note that the information on the user A may be the user ID of the account of the user A. Also, the terminal information may be an ID assigned to each pair of a service (an application or the vendor of the application) and a terminal 120 obtained by, for example, an application or a web browser on the terminal 120 using an API (Application Programming Interface) provided by the OS (Operating System) on the terminal 120.

The terminal 120A may transmit a request for using a service to the server 110, for example, when logging in to the server 110 by using the account of the user A, and going to use the service provided on the server 110 (e.g., when purchasing a product in an interpersonal trading service provided on the server 110).

Next, at Step 3, the server 110 transmits a request for obtaining the terminal state of the terminal 120A to the terminal management server 140. Here, the request for obtaining the terminal state may include the terminal information received from the terminal 120A.

Note that data of the terminal state managed on the terminal management server 140 is not changed even if the terminal 120 is initialized (reset to a state upon the factory shipment), cannot be changed by the user, and cannot be opted out of use by the user.

Next, at Step 4, the terminal management server 140 transmits the terminal state according to the received terminal information to the server 110. Here, the terminal management server 140 refers to the terminal management DB 141 to obtain the terminal state according to the terminal information, and replies to the server 110 with the obtained terminal state.

### (Terminal Management DB 141)

In the example in FIG. 5A, one or more application IDs in association with a terminal ID are recorded on the terminal management DB 141 of the terminal management server 140. Also, in association with each pair of a terminal ID and an application ID, terminal information and a terminal state are recorded.

The terminal ID may be any information as long as the terminal 120 can be uniquely identified with the ID. The terminal ID may be, for example, a serial number, IMEI (International Mobile Equipment Identity), MEID (Mobile Equipment Identifier), UDID (Unique Device Identifier), MAC address, or the like of the terminal 120. The terminal ID in the terminal management DB 141 may be registered in advance, for example, upon shipment of the terminal 120 from the factory or the like.

The application ID (service ID) may be identification information on the application, for example, for using a predetermined service installed on the terminal 120. Note that the application ID may be an ID assigned to each application or user. The terminal information may be any identifier as long as the server 110 or the terminal management server 140 can uniquely identify the terminal 120 with the identifier. The terminal information may be generated, for example, by the OS on the terminal 120 based on the terminal ID and the application ID described above. In this way, it is possible to manage the terminal state for each application and for each terminal. Note that in this case, the terminal information is, for example, information generated based on a terminal ID and an application ID, and may be a string obtained by encoding information encrypted by a predetermined encryption scheme, by the Base64 encoding scheme. In this case, the terminal information may also be referred to as a device token or the like. Also, the terminal information may be, for example, a query parameter (a query string) that is obtained by an application provided on the server 110 and installed on the terminal 120, and notified to the server 110 for the server 110 to obtain the terminal state from the terminal management server 140. These settings allow the server 110 to obtain the terminal state of a terminal without obtaining the terminal ID itself.

The terminal state is information that can be set and referenced by the application vendor related to an application ID, in association with a pair of a service provided by the vendor and the terminal 120. The terminal state may be set as two flags represented by, for example, two bits of data.

Note that for example, when a predetermined application is installed on the terminal 120 in response to an operation performed by the user or the like, the terminal 120 may transmit the terminal ID and the application ID of the predetermined application to the terminal management server 140. Then, the terminal management server 140 may associate the terminal ID with the application ID, to record the associated data in the terminal management DB 141. Then, the terminal management server 140 may generate terminal information that is unique for the pair of the terminal ID and the application ID, to record the generated terminal information on the terminal management DB 141 in association with the pair of the terminal ID and the application ID. Also, the terminal management server 140 may set the terminal state with respect to the generated terminal information to an initial value (e.g., two bits are both “0”, or “00” in the binary number notation), and record the set value on the terminal management DB 141.

Note that in the case where an application on the terminal 120 can use, for example, an API of the OS on the terminal 120 or the like to obtain the terminal ID such as a UDID, IMEI, MAC address, or the like that cannot be changed by the user, the server 110 can obtain the terminal ID of the terminal 120 from the application of the terminal 120. By making the terminal ID obtainable from the application of the terminal 120, for example, an external server can track the behavior of a particular user among multiple applications, and deliver behavioral targeting advertisements to the terminal 120. However, for example, there are users who want to reject behavioral targeting advertisements, and there are concerns on the privacy of the users; therefore, in recent years, such APIs have been abolished by the manufacturers of OSes, and in some cases, applications on the terminal 120 are configured to be incapable of obtaining the terminal ID.

Meanwhile, in recent years, for example, for users who want to allow behavioral targeting advertisements, there are applications on the terminal 120 that are capable of obtaining an advertisement ID, such as an IDFA (Advertising Identifier), an AAID (Google Advertising Identifier), and the like, by using the API of the OS on the terminal 120. This advertisement ID can be changed and can be opted out of use by the user; therefore, it may be difficult to use this ID for the purpose of recording illegal operations performed on the terminal.

According to the present embodiment, for example, in order to give a privilege granted when first installing the application on the terminal 120 (a bonus for initial installation), the server 110 uses an API provided by a manufacturer of the terminal 120 or the like, to record that the terminal 120 was used for an illegal operation, on the terminal management server 140 or the like on the side of the vendor of the terminal 120.

Next, at Step 5, the server 110 verifies the account state of the user A and the terminal state of the terminal 120A. Here, the server 110 refers to the user information storage unit 3151, and if the account state of the user A is “restricted”, replies to the terminal 120A with a notice indicating the state, and does not execute the following steps.

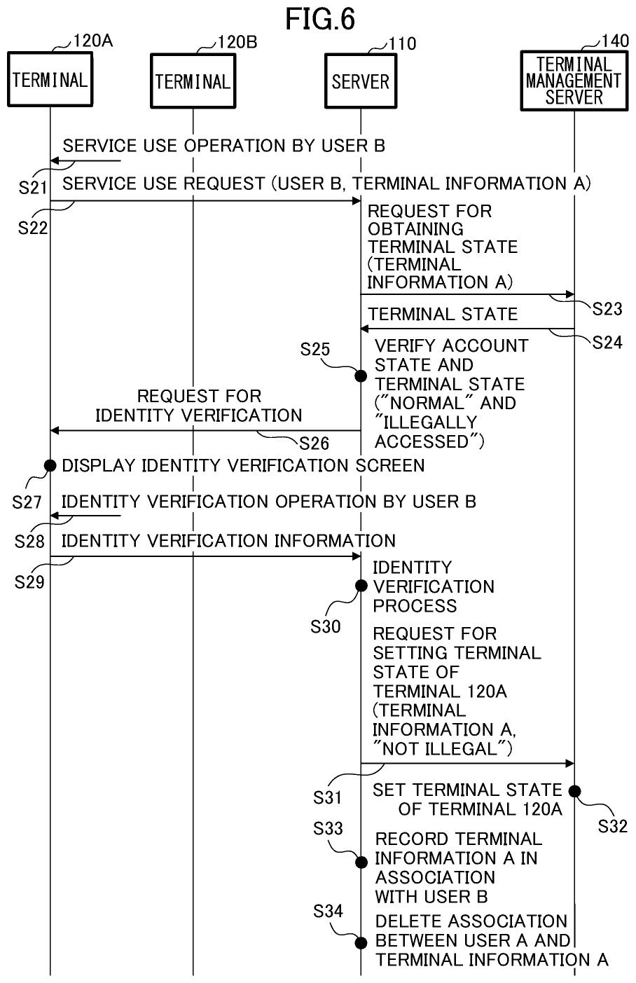

Also, in the case where the account state of the user A is “normal”, and the terminal state of the terminal 120A is “illegally accessed” (e.g., “01” in the binary number notation; an example of “predetermined information”), the server 110 does not execute the following steps, but executes similar processing as in Step S26 in FIG. 6, which will be described later.

On the other hand, if the account state of the user A is “normal” and the terminal state of terminal 120A is “not illegally accessed” (e.g., “00” in the binary number notation), the server 110 proceeds to the following steps.

### (User Information Storage Unit 3151)

In the example in FIG. 5B, in the user information storage unit 3151, in association with a user ID, a balance, a trade history, a settlement history, relationship information, personal information, an account state, and terminal information are stored. The user ID is identification information on the account of the user. The user ID may be specified by the user, for example, when the account was opened by the user in a service provided on the server 110. Also, for example, in the case where the user is authenticated with an account of a service other than the services provided on the server 110 (an external service), the user ID may be a user ID provided on a server providing the external service.

The balance is a balance of the electronic value used by the user for settlement in a settlement service provided on the server 110. The balance may be configured to accept a deposit, for example, from a bank account. Also, the balance may be configured to accept in a form of points or the like as the sales proceeds when a product was sold (traded) in an interpersonal trading service provided on the server 110.

The trade history (buying and selling history) is information on a history of buying and selling (trading) of products in an interpersonal trading service provided on the server 110. The settlement history is information on a settlement history made in a settlement service provided on the server 110.

The relationship information is information on other users each having a predetermined relationship with the user related to the user ID. The relationship information may include information on, for example, other users registered as having a relationship of a friend, a follow-up, and the like by the user related to the user ID in an SNS (Social Networking Service) provided on the server 110. Also, the relationship information may also include information on other users based on an interpersonal remittance history in a settlement service; information on other users to whom the user related to the user ID has transferred money; and information on other users who have transferred money to the user related to the user ID.

Also, the relationship information may also include information on other users on a social graph. For example, the relationship information may include information on other users who have registered the user related to the user ID as a follow-up in an interpersonal trading service. Also, the relationship information may include information on other users who have done trading that satisfies a predetermined condition in an interpersonal trading service. The predetermined condition may be, for example, such that a product is purchased within a predetermined time (e.g., 2 minutes) after listed to the interpersonal trading service. This is because there is a likelihood that the users have a relationship that allows them to communicate with each other via e-mail, SNS, and the like in advance before listing the product to the interpersonal trading service. Also, the predetermined condition may be such that a notice of shipment completion of a product reaches within a predetermined time (e.g. 2 minutes) from the time of purchase of the product. This is because it is normally impossible to ship a product within such a short period of time after the purchase, and there is a likelihood of an illegal trade.

The personal information is personal information on the user related to the user ID. The personal information may include, for example, the name, date of birth, address, bank account, ID card data, and facial image of the user. The bank account may be, for example, information on a bank account number in the name of the user related to the user ID. The bank account may be registered by the user to make a deposit in the balance in a settlement service provided on the server 110 from the balance of the bank account. Also, the bank account may be registered by the user to make a deposit into the bank account with sales proceeds of a product in an interpersonal trading service.

The ID card data is information on an ID card of the user related to the user ID. The ID card data may be, for example, image data of the driver's license, the individual number card, or the like that has been photographed on the terminal 120 of the user and transmitted to the server 110.

The facial image is a facial image of the user related to the user ID. For example, the facial image may be generated from a moving image captured on the terminal 120 of the user along with an ID card and transmitted to the server 110, so that the user can use a predetermined service provided on the server 110.

The account state is a state of the account of the user related to the user ID. States of an account may include, for example, “normal”, “restricted”, and the like. Here, “restricted” may be a state in which the use of the account is restricted due to, for example, an illegal operation performed by the user.

The terminal information is information related to the terminal 120 used by the user related to the user ID when the user used a predetermined service provided on the server 110. The terminal information may be terminal information recorded on the terminal management DB 141 of the terminal management server 140 in FIG. 5A.

Note that the terminal information may be identification Information of the terminal 120, for example, a serial number, IMEI (International Mobile Equipment Identity), MEID (Mobile Equipment Identifier), UDID (Unique Device Identifier), MAC address, or the like of the terminal 120. In this case, the server 110 may be configured to manage the terminal state in association with the terminal information in the user information storage unit 3151 or the like of the server 110, instead of managing the terminal state in association with the terminal information in the terminal management DB 141 of the terminal management server 140 in FIG. 5A.

Next, at Step 6, the server 110 associates the terminal information on the terminal 120A with the user A, and records the associated data on the user information storage unit 3151. Here, the server 110 may permit the use of services to be performed by the user A only if the user A is successfully authenticated. The server 110 may perform the authentication based on, for example, the user ID and password of the user A.

Alternatively, the server 110 may perform the authentication based on, for example, the user ID and password of the user A, and the terminal information. In this case, the server 110 may determine that authentication is successful if the user ID, password, and terminal information on the user A received from the terminal 120A match the user ID, password, and terminal information on the user A stored in the user information storage unit 3151. Then, in the case where the user ID and the password match, but the terminal information received from the terminal 120A is not recorded in association with the user A on the user information storage unit 3151, the server 110 may record the terminal information on the terminal 120A in association with the user A, in the user information storage unit 3151. In this case, for example, the server 110 may transmit a code (one-time password) using an SMS (Short Message Service) or the like to the phone number of the user A, and only in the case where the code entered by the user A is received from the terminal 120A, the server 110 determines that the two-stage authentication succeeded, and records the terminal information on the terminal 120A in the user information storage unit 3151.

Next, at Step 7, the terminal 120B receives an operation for using a service provided on the server 110 from the user A. Here, the user A owns, for example, the terminal 120A and the terminal 120B, and uses services on the server 110 from the multiple terminals 120 using the same account. For example, the user A may use a settlement service by using the terminal 120A, which may be a smartphone or the like, and use an interpersonal commerce service by using the terminal 120B, which may be a tablet or the like.

Next, at Step 8, the terminal 120B transmits a request for using the service that includes information on the user A and terminal information on the terminal 120B (terminal Information B) to the server 110. Next, at Step 9, the server 110 transmits a request for obtaining the terminal state of the terminal 120B to the terminal management server 140. Next, at Step 10, the terminal management server 140 transmits the terminal state according to the received terminal information to the server 110. Next, at Step 11, the server 110 verifies the account state of the user A and the terminal state of the terminal 120B. Next, at Step 12, the server 110 associates the terminal information on the terminal 120B with the user A, and records the associated data on the user information storage unit 3151. Note that the processing from Step S7 to Step S12 may be executed in substantially the same way as in the processing from Step S1 to Step S6 described above, because only the terminal 120 is different.

Next, at Step 13, the server 110 detects an illegal operation performed by the user A. Here, the server 110 may detect illegal operations such as, for example, the user A sold a fake product in an interpersonal trading service; the user A committed a fraud by sending a notice of shipment completion of a product in an interpersonal trading service but not sending the product; or the like. Also, the server 110 may detect illegal operations such as, for example, the user A made settlement using a stolen credit card; the user A failed to make timely payment of money in the case of purchasing a product with deferred payment; or the like.

Next, at Step 14, the server 110 restricts the use of services on the account of the user A. Here, for example, the server 110 may deny login to the account of the user A.

Next, at Step 15, the server 110 transmits a request for setting the terminal state to “illegally accessed” for each terminal 120 associated with the user A, to the terminal management server 140. Here, the server 110 obtains the terminal information on each terminal associated with the user A (the terminal information A and the terminal information B) that is recorded on the user information storage unit 3151 in FIG. 5A. Then, the server 110 transmits a request for setting the terminal state associated with the terminal information on each terminal to “illegally accessed” to the terminal management server 140. Here, the request may include the terminal information on each terminal 120 and “not illegally accessed”, which is a value of the terminal state to be set.

Next, at Step 16, the terminal management server 140 sets the terminal state according to the received terminal information, to “illegally accessed” in the terminal management DB 141. In this way, the subsequent use of services on each terminal 120 used by the user A will be restricted.

Note that at Step S15 and Step S16, the server 110 and the terminal management server 140 may set the terminal states of the terminals 120 one by one. In this case, the server 110 first transmits a setting request that includes the terminal information A and “illegally accessed” as the value of the terminal state to be set, to the terminal management server 140, and causes the terminal state of the terminal 120A to be set to “illegally accessed”. Then, the server 110 may transmit a setting request that includes the terminal information B and “illegally accessed” as the value of the terminal state to be set, to the terminal management server 140, to cause the terminal state of the terminal 120B to be set to “illegally accessed”.

### <<Processing of Canceling Restrictions of the Use of Services on the Terminal 120>>

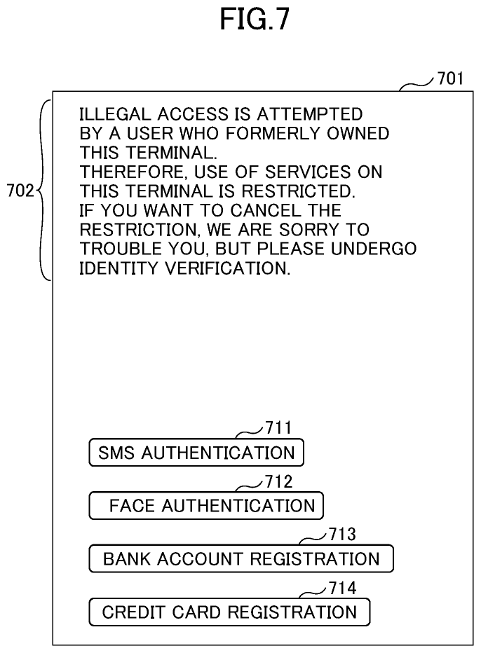

Next, with reference to FIGS. 6 and 7, an example of processing of canceling restrictions of the use of services using the terminal 120 will be described. FIG. 6 is a diagram illustrating an example of a sequence of steps for canceling restrictions of the use of services on an illegally used terminal according to an embodiment. FIG. 7 is a diagram illustrating an example of a display on the terminal 120 according to an embodiment.

Note that the user B (an example of a “second user”) may be a user, for example, who purchased the terminal 120A sold by the user A or the like using an interpersonal trading service or a dealer of used products.

At Step S21, the terminal 120A receives an operation for using a service provided on the server 110 from the user B. Next, at Step 22, the terminal 120A transmits information on the user B and a request for using the service including terminal information on the terminal 120A to the server 110. Next, at Step 23, the server 110 transmits a request for obtaining the terminal state of the terminal 120A to the terminal management server 140. Next, at Step 24, the terminal management server 140 transmits the terminal state according to the received terminal information to the server 110.

Next, at Step 25, the server 110 verifies the account state of the user B and the terminal state of the terminal 120A. Here, the server 110 refers to the user information storage unit 3151, and if the account state of the user B is “restricted”, replies to the terminal 120A with a notice indicating the state, and does not execute the following steps.

Note that the processing from Step S21 to Step S25 may be executed in substantially the same way as in the processing from Step S1 to Step S6 in FIG. 4 described above, because only the user is different. In the case where the account state of the user B is “normal”, and the terminal state of the terminal 120A is “not illegally accessed”, the server 110 provides the services as usual, without performing the following steps.

In the case where the account state of the user B is “normal”, and the terminal state of the terminal 120A is “illegally accessed”, the server 110 proceeds to the following steps.

### (Restoration Process)

Next, at Step 26, the server 110 transmits a request for identity verification to the terminal 120A. Next, at Step 27, the terminal 120A displays information based on the received request for identity verification on the screen. Here, the terminal 120A displays a screen for inputting information for identity verification. In the example in FIG. 7, on an identity verification screen 701 for restoring the illegally used terminal, the terminal 120A displays a message 702 and the like stating that identity verification is required to use services using the terminal 120A because a user has illegally accessed the terminal 120A.

Next, at Step 28, the terminal 120A receives an operation for inputting information for identity verification from the user B. Next, at Step 29, the terminal 120A transmits the input information for identity verification of the user B to the server 110.

Next, at Step 30, the server 110 performs processing of identity verification of the user B. Here, in the case where an “SMS Authentication” button 711 in FIG. 7 is pressed by the user B, for example, the server 110 may transmit a code (one-time password) to the telephone number of the user B registered in the user information storage unit 3151 by using an SMS or the like. Then, the server 110 may determine that the identity verification is successful if the code input by the user B is received from the terminal 120A.

Also, in the case where a “Face Authentication” button 712 in FIG. 7 is pressed by the user B, the server 110 may perform identity verification based on, for example, a facial image of the user B photographed on the terminal 120A. In this case, the server 110 may activate, for example, a photograph function using a camera, which is provided by the OS on the terminal 120A or an application installed on the terminal 120A, to obtain from the terminal 120A an image in which the face of the user B and an ID card with a photograph are photographed at the same time. Then, the server 110 may determine whether or not the face of the user B and the face in the photograph of the ID card are of the same person by AI or the like, and if it is determined that the faces are of the same person, determine that the identity verification is successful. Alternatively, the server 110 may perform identity verification based on an image of the face of the user B photographed using an application installed on the terminal 120A, and an identification photograph included in the ID card data of the user B registered in advance in the user information storage unit 3151.

Also, in the case where a “Bank Account Registration” button 713 in FIG. 7 is pressed by the user B, the server 110 may display a screen for inputting information on the bank account for making a deposit or the like on the balance of the user B in a settlement service provided on the server 110. Then, in the case where the bank account in the name of the user B has been registered by the user B, and authentication of the user B by the bank is successful, the server 110 may determine that the identity verification is successful.

Also, in the case where a “Credit Card Registration” button 714 in FIG. 7 is pressed by the user B, the server 110 may display a screen for inputting information on the bank account for making a deposit or the like on the balance of the user B in a settlement service provided on the server 110. Then, in the case where the credit card information in the name of the user B has been registered by the user B in a settlement service provided on the server 110, and authentication of the user B by the credit card company is successful, the server 110 may determine that the identity verification is successful.

Note that if the identity verification has failed, the server 110 replies to the terminal 120A with a notice of the failure, and does not perform the following steps. On the other hand, if the identity verification has succeeded, the server 110 proceeds to the following steps.

Next, at Step 31, the server 110 transmits a request for setting the terminal state of the terminal 120A to “not illegally accessed”, to the terminal management server 140. Here, the request may include the terminal information on the terminal 120A and “not illegally accessed”, which is a value of the terminal state to be set.

Next, at Step 32, the terminal management server 140 sets the terminal state according to the received terminal information, to “not illegally accessed” in the terminal management DB 141. In this way, thereafter, on the terminal 120A used by the user A who has committed an illegal operation, restrictions of the use of services provided on the server 110 are canceled. Therefore, for example, flea market services and interpersonal trading services such as Internet auctions, stores of used products, and the like become usable, and in the case where the illegally used terminal is obtained by a user in good faith, the terminal 120 once treated as an illegally used terminal can be restored.

Next, at Step 33, the server 110 associates the terminal information on the terminal 120B with the user A, and records the associated data on the user information storage unit 3151.

Next, at Step 34, the server 110 deletes the terminal information on the terminal 120A associated with a user other than the user B in the user information storage unit 3151. Thus, in the user information storage unit 3151, the association between the user A who has committed an illegal operation and the terminal 120A is deleted.

In the following, examples of processing in the present embodiment will be described. Processing in each of the following application examples can be performed in combination with the processing of the other application examples.

### First Application Example

In the first application example according to the present embodiment, in the case where a user using an illegally used terminal has a predetermined relationship with an illegal user, the use of services is restricted. According to the first application example, for example, in the case where illegal operations are conducted systematically, illegal operations performed by a user having a predetermined relationship with an illegal user can be reduced.

### Processing in the First Application Example

In the first application example, in the processing at Step S30 in FIG. 6, the server 110 determines whether or not the user B has a predetermined relationship with the user A. Then, if the user B does not have a predetermined relationship, the processing at Step S31 and thereafter in FIG. 6 is performed; or if the user B has a predetermined relationship, the processing at Step S31 and thereafter in FIG. 6 is not performed. Note that by executing Step S30 before processing of identity verification, the load required for the processing of identity verification can be reduced.

For example, the server 110 may determine the presence or absence of a predetermined relationship based on at least one of the trading history of the user A and the user B in an interpersonal trading service; the relationship between the user A and the user B in an SNS (Social Networking Service); and the interpersonal remittance history between the user A and the user B in a settlement service. In these cases, the server 110 refers to, for example, the user information storage unit 3151 in FIG. 5B, and if the user B is recorded on the relationship information of the user A, and the user A is recorded on the relationship information of the user B, may determine that the user B has a predetermined relationship with the user A.

Also, the server 110 may determine the presence or absence of a predetermined relationship based on, for example, the positional relationship between the user A and the user B. In this case, if an address registered by the user A and positional information when the user A used a service, and an address registered by the user B and positional information when the user B used the service are within a predetermined range, the server 110 may determine that the user B has a predetermined relationship with the user A; or if not within the predetermined range, may determine that there is no predetermined relationship. This is because if the positions of the user A and the user B are within a predetermined range, the user A may have handed the illegally used terminal to the user B.

### Second Application Example

In the second application example according to the present embodiment, after an illegally used terminal 120 is restored, if another user who uses the restored terminal 120 performs an illegal operation, restoration of the corresponding terminal 120 is restricted thereafter. According to the second application example, for example, in the case where the user B who uses the terminal 120 used by the illegal user A also performs an illegal operation, the use of services using the terminal 120 by a user C can be restricted. In this way, for example, it is possible to prevent three or more illegal operations using the same terminal 120.

### Processing in the Second Application Example

In the second application example, at Step S31 in FIG. 6, the terminal state of the terminal 120A to be restored upon successful identity verification of the user B is set to “not illegally accessed (once illegally accessed by another user)” (e.g., “10” in the binary number notation).

Then, in the case of detecting an illegal operation performed by the user B in substantially the same processing as illustrated in FIG. 4 for the user B, the server 110 obtains the terminal state of the terminal 120A from the terminal management server 140, and if the obtained terminal state is “not illegally accessed (once illegally accessed by another user)”, transmits a request for setting the terminal state of the terminal 120A to “permanently restricted” (e.g., “11” in the binary number notation) to the terminal management server 140.

Then, if the terminal state of the terminal 120A is “permanently restricted” in substantially the same processing as illustrated in FIG. 6 for the user C, the server 110 transmits a message indicating the state to the terminal 120A, and does not perform restoration processing at Step S26 and thereafter in FIG. 6.

### Third Application Example

In the third application example according to the present embodiment, the upper limit of deferred payment in a settlement service provided on the server 110 is determined based on the value of the terminal 120 of the user. According to the third application example, it is possible to reduce motivation to commit illegal operations, for example, by making a profit obtained from an illegal operation such as repudiation (non-payment) of a debt of deferred payment lower than the value of the terminal 120 of the user.

### Processing in the Third Application Example

In the third application example, the server 110 may estimate the value of each terminal 120 used by the user A (the terminal 120A and the terminal 120B), based on the trading history in an interpersonal trading service provided on the server 110. In this case, the server 110 calculates a representative value (e.g., mean, median, mode, and the like) among prices at which similar models as the terminal 120A were sold, and a representative value among prices at which similar models as the terminal 120B were sold, for example, in the trading history for a predetermined period (e.g., within one month) from the present time. Then, the amount of money less than the sum of the calculated representative values may be determined as the upper limit of deferred payment in a settlement service provided on the server 110.

### Fourth Application Example

In the fourth application example according to the present embodiment, information on an illegally used terminal is provided to a third party. According to the fourth application example, for example, illegal operations in services provided by other providers affiliated with the provider of the server 110 can be reduced.

### Processing in the Fourth Application Example

In the fourth application example, a third-party application (application B) installed on the terminal 120A executes an API provided by the provider of the server 110 when the user A performs a login, to activate an application (application A) of the provider of the server 110 installed on the terminal 120A.

The application A displays an authentication screen for the account of the user A on the server 110. Then, the user A undergoes authentication with the user ID and password of the account of the user A on the server 110. If the authentication is successful, the server 110 transmits information including the terminal state of the terminal 120A obtained from the terminal management server 140 and the account state of the user A, to the application B.

1. An information processing method executed by an information processing apparatus including a memory and a processor, the method comprising:
recording a first user in association with a first information processing terminal used by the first user; and
restricting use of a service using the first information processing terminal by the first user and a second user, in response to detecting an illegal operation performed by the first user.

2. The information processing method as claimed in claim 1, wherein the restricting registers predetermined information by using first pair identification information corresponding to a pair of the service and the first information processing terminal obtained from the first information processing terminal, in response to detecting the illegal operation performed by the first user.

3. The information processing method as claimed in claim 2, wherein the restricting registers, in response to detecting illegal operation performed by the first user, predetermined information by using the first pair identification information, on an external information processing apparatus configured to manage pair identification information and identification information on the information processing terminal, and
by using the pair identification information obtained from the first information processing terminal used by the second user, in a case where information obtained from the external information processing apparatus is equivalent to the predetermined information, restricts the use of the service by the second user using the first information processing terminal.

4. The information processing method as claimed in claim 1, further comprising:
canceling the restriction of the use of the service using the first information processing terminal, in response to receiving a request for using the service from the first information processing terminal used by the second user, and in a case where identity verification of the second user is successful.

5. The information processing method as claimed in claim 4, wherein the canceling performs the identity verification of the second user, based on at least one of a facial image of the second user photographed on the first information processing terminal, information on a bank account of the second user, and information on a credit card of the second user.

6. The information processing method as claimed in claim 4, wherein in a case where the first user has a predetermined relationship with the second user, the canceling of the restriction of the use of the service using the first information processing terminal is not performed, and
in a case where the first user does not have a predetermined relationship with the second user, the canceling of the restriction of the use of the service using the first information processing terminal is performed.

7. The information processing method as claimed in claim 6, wherein the canceling determines presence or absence of a predetermined relationship based on at least one of a trading history of the first user and the second user in an interpersonal trading service; a relationship between the first user and the second user in an SNS (Social Networking Service); an interpersonal remittance history between the first user and the second user in a settlement service; and a positional relationship between the first user and the second user.

8. The information processing method as claimed in claim 4, wherein in a case where the identity verification of the second user is successful, the canceling deletes the recording of the first user in association with the first information processing terminal, and records the second user in association with the first information processing terminal.

9. The information processing method as claimed in claim 4, further comprising:
restricting the canceling of the restriction of the use of the service using the first information processing terminal, after having detected the illegal operation performed by the first user, in response to detecting an illegal operation of the service performed by the second user using the first information processing terminal.

10. The information processing method as claimed in claim 1, wherein the illegal operation includes no payment of a price, and the method further comprising:
determining an upper limit of deferred payment for the first user, based on a value of the first information processing terminal used by the first user.

11. The information processing method as claimed in claim 10, wherein the determining estimates the value of the first information processing terminal, based on a trading history in an interpersonal trading service.

12. An information processing apparatus comprising:
a memory; and
a processor configured to execute recording a first user in association with a first information processing terminal used by the first user; and
restricting use of a service using the first information processing terminal by the first user and a second user, in response to detecting an illegal operation performed by the first user.

13. A non-transitory computer-readable recording medium having computer-readable instructions stored thereon, which when executed, cause an information processing apparatus including a memory and a processor to execute an information processing method, the method comprising:
recording a first user in association with a first information processing terminal used by the first user; and
restricting use of a service using the first information processing terminal by the first user and a second user, in response to detecting an illegal operation performed by the first user.
